(19) United States
(12) Patent Application Publication
(10) Pub. No.: US 2003/0024054 A1
(43) Pub. Date: Feb. 6, 2003

(54) Stability enhanced hydrophobic peracid bleaching systems for textile applications and methods for using same

(76) Inventors: Michael Eugene Burns, Liberty Twsp, OH (US); Scott William Capeci, Northbend, OH (US); Richard David McLane, Liberty Township, OH (US); Cynthia Marie Stark, Cincinnati, OH (US); Jiping Wang, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/186,136

(22) Filed: Jun. 28, 2002

Related U.S. Application Data
(60) Provisional application No. 60/302,510, filed on Jun. 29, 2001.

(51) Int. Cl. A01N 1/00; D06M 10/00

(52) U.S. Cl. 8/115.51; 252/186.26

(57) ABSTRACT

Stability enhanced hydrophobic bleaching systems for textile applications and methods for using are provided. The bleaching systems comprise a hydrophobic peracid and a peracid stabilizing system of a preferred ratio of peracid to stabilizer. Preferred stabilizers to be used in conjunction with the hydrophobic peracids include diphosponic, multiphosphonic and amino phosphonic acid derivatives.

### CROSS REFERENCE TO RELATED APPLICATIONS

This application claims priority under 35 U.S.C. §119(e) to U.S. Provisional Application Serial No. 60/302,510, filed Jun. 29, 2001 (Attorney Docket No.8616P).

### TECHNICAL FIELD

The present invention relates to stability enhanced hydrophobic peracid bleaching systems for textile applications, and even more particularly to the use of specialized stabilizer systems for stabilizing peracid in the bleaching solution.

### BACKGROUND OF THE INVENTION

In the industrial textile processing of natural fibers, yarns and fabrics, a pretreatment or preparation step is typically required to properly prepare the natural materials for further use and in particular for the dyeing and/or finishing stages typically required for commercial goods. These textile treatment steps remove impurities and color bodies, either naturally existing or those added by the spinning and weaving steps to the fibers and/or fabrics.

A common pretreatment step involves bleaching to destroy naturally occurring color bodies. This bleaching step provides a uniform white appearance for consumer acceptable whites as well as provides a uniform base for dyeing, printing or additional finishing steps. Thus, a highly successful bleaching step is necessary for commercially acceptable consumer fabrics. Traditional textile bleaching of natural fibers has involved the use of hydrogen peroxide. Hydrogen peroxide has gained its wide acceptance due to its flexibility of use being capable in both hot and rapid or cold and long dwell bleaching processes and due to its environmental friendliness.

While hydrogen peroxide has gained wide spread acceptance in the textile industry, it is not a particularly effective bleaching agent. Hydrogen peroxide, as commercially supplied, is an extremely stable compound and as a result has only a slight bleaching effect on natural fibers. To overcome its weak activity, extremely high temperatures and/or extremely long bleaching times are required in commercial processes in addition to activation of the peroxide. That is, temperatures in excess of 95° C. are typically required. In addition, activation of the peroxide via the use of alkali, sulfuric acid, UV irradiation, hypochlorite or organic activators is also necessary with alkali being the most preferred. Not only do these drawbacks result in excessive cost associated with commercial textile peroxide bleaching, but the high temperatures and/or long contact times result in significant fiber damage and strength reduction of the resultant yarns and fabrics.

Hydrophobic bleach activators, such as nonanoyloxybenzene sulfonate, sodium salt (NOBS) have been employed in consumer laundry detergent applications such as Tide® with Bleach to work in conjunction with peroxygen sources to provide activated bleaching in consumer laundering of garments. However, the severe conditions employed in the bleaching of textiles have heretofore prevented the successful application of laundry detergent bleaching technology in textile mill applications. The lack of stability of these hydrophobic bleach systems under the conditions in which they are employed in textile bleaching is a major contributing factor to this lack of success. Indeed, EP 584,710 discloses the use of activated bleaching in textile mill applications wherein hydrophobic activators are briefly disclosed along with a multitude of other classes and types of activators. While they are disclosed, there is no successful application of hydrophobic bleaching technology where acceptable whiteness values are achieved while damage to fabrics and fibers is minimized. Indeed, EP 584,710 specifies that in order to achieve acceptable whiteness benefits, additional alkali bleaching is necessary which will dramatically increase fiber damage. Thus, a stable, effective hydrophobic bleaching system for use in industrial textile applications is heretofore unknown.

Accordingly, the need remains for a stable hydrophobic bleaching treatment method for effective bleaching in textile applications which can provide superior whiteness benefits, especially at reduced bleaching temperatures and times while providing improved fabric strength retention versus conventional textile bleaching processes.

### SUMMARY OF THE INVENTION

The aforementioned needs are provided via the present invention wherein a stability enhanced bleaching method and composition are provided. The present invention involves the use of hydrophobic peracid bleaching systems in conjunction with a peracid stabilizing system to produce the superior bleaching properties of the present invention. Hydrophobic peracid bleaching systems while heretofore being known have been unable to achieve a commercial acceptable result from traditional bleaching. Indeed, additional damaging bleaching steps or materials were required in order to produce commercially acceptable goods.

While not wishing to be bound by theory, it is believed that the hydrophobic peracid of the present invention provides better absorbency on the fabrics and yarns and better “wetting” of the surface of the fibers than conventional peroxide bleaching techniques or hydrophilic activators. Hydrophobic bleach activators form the active bleaching species, peracid, on the surface of the fabric allowing a longer time on the surface of the fabric. Hydrophilic activators, meanwhile, form peracid in solution and must then undergo a fabric solution interaction which is less efficient. As a result, the hydrophobic bleaching agents of the present invention provide superior bleaching and whiteness while minimizing fiber damage and strength reduction.

However, the present invention delivers peracid bleaching systems capable of superior whiteness and fabric strength retention benefits via the discovery and use of a peracid stabilization system. While not wishing to be bound by theory, it has been discovered via the present invention that poor water quality in textile processing leads to ineffective performance of hydrophobic peracid bleaching systems. In particular, the presence of elevated levels of iron, calcium and magnesium contribute to instability of the peracid and ineffective bleaching performance. Accordingly, via the use of the present invention superior textile bleaching performance in hydrophobic peracid bleaching systems may be achieved. The present invention involves the use of specific ratios of peracid generated to the stabilization system of from about 1:1 to about 100:1 to deliver these unexpected results.

In preferred embodiments of the present invention, the hydrophobic peracid is formed from the combination of hydrogen peroxide and a hydrophobic bleach activator and the stabilizing system comprises one or more organic phosphonic acids or organic phosponates more particularly, one or more compounds selected from the group consisting of 1-hydroxyethylidene-1,1-diphosphonic acid, amino penta (methylenephosphonic acids), amino tetra (methylenephosphonic acids), amino tri (methlyenephosphonic acids) and mixtures thereof. The resultant treated textile component has a whiteness value on the CIE index of at least about 70 or a fiber degradation increase of less than 25%.

The peracid employed in the present invention may be preferably delivered via the use of a textile hydrophobic bleach precursor composition which comprises at least about 8% by weight of a hydrophobic bleach precursor and stabilizing amount of a chelant stabilizing system wherein the ratio of activator to chelant is from about 2:1 to about 20:1 active weight basis. Preferably the composition is in slurry form and comprises at least about 50% by weight of the hydrophobic bleach precursor. Even more preferred is a delivery mechanism whereby the bleach precursor composition comprises at least a first composition having at least about 10% by weight of a hydrophobic bleach precursor and at least a second composition having a stabilizing amount of a chelant stabilizing system.

All percentages, ratios and proportions herein are on a 100% weight basis unless otherwise indicated. All documents cited herein are hereby incorporated by reference.

### DETAILED DESCRIPTION OF THE PREFERRED EMBODIMENTS

According to the present invention, a superior textile treatment process for fibers, yarns and fabrics, both knitted and woven, is provided. The proper preparation of a textile component such as a fiber, yarn or fabric is critical to the success of further treatment in the manufacture of commercially acceptable textile components such as yarns, fabrics, garments, and the like. These treatment steps include dyeing, printing and/or additional steps finishing such as application of durable press finishes. Uneven color appearance or impurities such as waxes or oils on the surface of the textile prevent the uniform application of many treatments. Present commercial textile preparation methods, and, in particular, textile bleaching methods, remain unsatisfactory due to the fiber and fabric damage of the treated textiles, high costs associated with the high temperatures necessary to drive bleaching, high costs due to extra equipment necessary for separate treatment steps for de-sizing, scouring and bleaching, and environmental unfriendliness due to an excess of toxic salts in the waste.

The present invention provides a cost effective and superior performing alternative to the conventional processing. The present invention involves the use of a hydrophobic peracid bleaching system for the bleaching of non-finished textile components. Hydrophobic peracid bleaching provides superior results in the context of textile whiteness and in fabric strength retention when used in conjunction with the peracid stabilizing system of the present invention. While conventional textile bleaching processes require high temperatures of more than 95° C. to achieve satisfactory whiteness values of more than 70 on the CIE whiteness index, the result is a degradation of the strength of the fabric of 15% and more of the original fabric strength and a degradation of the fibers of 50% or more. The method of the present invention provides satisfactory whiteness values of more than 70 on the CIE whiteness index while delivering superior fabric strength retention by providing a fabric strength reduction of less than about 10%, more preferably less than about 5% and most preferably less than about 3% of the original fabric strength. Additionally, the method of the present invention provides a degradation of the fibers of less than 25%, more preferably less than 15% and even more preferably of no more than 10% whereby an increase in degradation represents an increase in fiber damage. Accordingly, the use of the method of the present invention results in a significant reduction in fiber damage as opposed to conventional bleaching technology of peroxide at more than 95° C. which produces significantly higher degradation.

The present invention involves the use of an aqueous bleaching solution of a hydrophobic peracid in either hot processing, that is, processing at elevated temperatures, in both batch and continuous conditions, or cold processing taking place at room temperatures. The peracid may be formed in situ in the bleaching solution or be supplied via a pre-formed hydrophobic peracid with the in situ formation preferably from the combination of hydrogen peroxide and a hydrophobic bleach activator. The hydrogen peroxide or pre-formed peracid is present in the bleaching solution of the present invention at levels of from about 1 to about 40 g/L, more preferably from about 1 to about 30 g/L and most preferably from about 1.5 to about 20 g/L for continuous processing; from about 1 to about 20 g/L, more preferably from about 1 to about 10 g/L and most preferably from about 1.5 to about 5 g/L for hot batch or from about 1 to about 50 g/L, more preferably from about 5 to about 40 g/L and most preferably from about 10 to about 30 g/L in cold processing. The hydrophobic activator is then employed at molar ratios of activator to peroxide of from about 1:1 to about 1:50, more preferably from about 1:2 to about 1:30 and even more preferably from about 1:5 to about 1:20 in hot processing with 1:3 to about 1:15 being most preferred in cold processing.

Particularly useful and preferred for the generation of hydrophobic peracid is the combination of hydrogen peroxide and hydrophobic bleach activators, and in particular the alkanoyloxy class of bleach activators having the general formula:

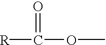

wherein R is an alkyl chain having from about 5 to about 17, preferably from about 7 to about 11 carbon atoms and L can be essentially any suitable leaving group. A leaving group is any group that is displaced from the bleaching activator as a consequence of the nucleophilic attack on the bleach activator by the perhydroxide anion. This, the perhydrolysis reaction, results in the formation of the peroxycarboxylic acid. Generally, for a group to be a suitable leaving group it must exert an electron attracting effect. It should also form a stable entity so that the rate of the back reaction is negligible. This facilitates the nucleophilic attack by the perhydroxide anion.

The L group must be sufficiently reactive for the reaction to occur within the optimum time frame. However, if L is too reactive, this activator will be difficult to stabilize for use in a bleaching composition. These characteristics are generally paralleled by the pKa of the conjugate acid of the leaving group, although exceptions to this convention are known. Ordinarily, leaving groups that exhibit such behavior are those in which their conjugate acid has a pKa in the range of from about 4 to about 13, preferably from about 6 to about 11 and most preferably from about 8 to about 11. For the purposes of the present invention, L is selected from the group consisting of:

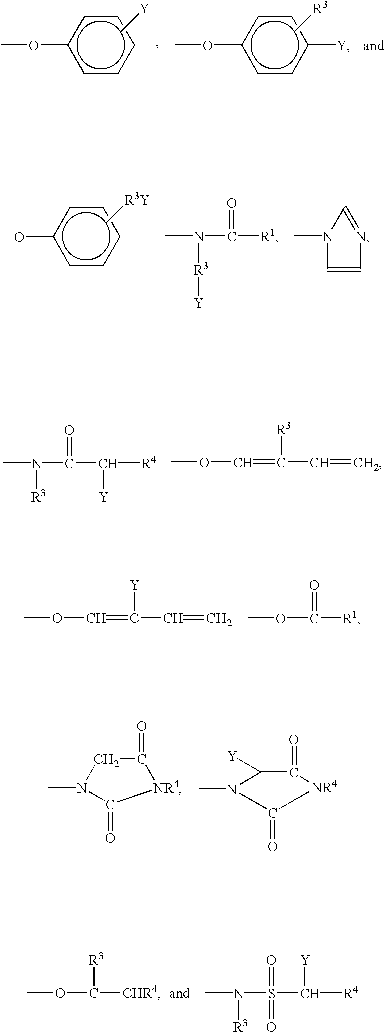

and mixtures thereof, wherein R¹ is an alkyl, aryl, or alkaryl group containing from about 1 to about 14 carbon atoms, R³ is an alkyl chain containing from 1 to about 8 carbon atoms, R⁴ is H or R³, and Y is H or a solubilizing group.

The preferred solubilizing groups are —SO₃⁻M⁺, —CO₂⁻M⁺, —SO₄⁻M⁺, −N⁺(R³)₄X⁻ and O←N(R³)₃ and most preferably —SO₃⁻M⁺ and —CO₂⁻M⁺ wherein R³ is an alkyl chain containing from about 1 to about 4 carbon atoms, M is a cation which provides solubility to the bleach activator and X is an anion which provides solubility to the bleach activator. Preferably, M is an alkali metal, ammonium or substituted ammonium cation, with sodium and potassium being most preferred, and X is a halide, hydroxide, methylsulfate or acetate anion.

Preferred bleach activators are those of the above general formula wherein L is selected from the group consisting of:

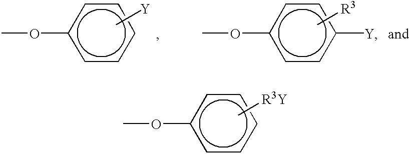

wherein R³ is as defined above and Y is —SO₃⁻M⁺ or —CO₂⁻M⁺ wherein M is as defined above.

Most preferred among the bleach activators of use in the present invention, are alkanoyloxybenzenesulfonates of the formula:

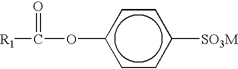

wherein R₁ contains from about 7 to about 12, preferably from about 8 to about 11, carbon atoms and M is a suitable cation, such as an alkali metal, ammonium, or substituted ammonium cation, with sodium and potassium being most preferred.

Highly preferred hydrophobic alkanoyloxybenzenesulfonates are selected from the group consisting of nonanoyloxybenzenesulfonate, 3,5,5-trimethylhexanoyloxybenzene-sulfonate, 2-ethylhexanoyloxybenzenesulfonate, octanoyloxybenzenesulfonate, decanoyl-oxybenzenesulfonate, dodecanoyloxybenzenesulfonate, and mixtures thereof.

Alternatively, amido derived bleach activators may be employed in the present invention. These activators are amide substituted compounds of the general formulas:

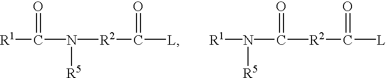

or mixtures thereof, wherein R¹ is an alkyl, aryl, or alkaryl group containing from about 1 to about 14 carbon atoms, R² is an alkylene, arylene or alkarylene group containing from about 1 to about 14 carbon atoms, R⁵ is H or an alkyl, aryl, or alkaryl group containing from about 1 to about 10 carbon atoms and L is a leaving group as defined above.

Preferred bleach activators are those of the above general formula are wherein R¹ is an alkyl group containing from about 6 to about 12 carbon atoms, R² contains from about 1 to about 8 carbon atoms, and R⁵ is H or methyl. Particularly preferred bleach activators are those of the above general formulas wherein R¹ is an alkyl group containing from about 7 to about 10 carbon atoms and R² contains from about 4 to about 5 carbon atoms and wherein L is selected from the group consisting of:

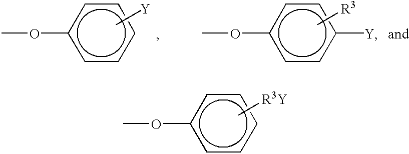

wherein R³ is as defined above and Y is —SO₃⁻M⁺or —CO₂⁻M⁺ wherein M is as defined above.

Another important class of bleach activators provide organic peracids as described herein by ring-opening as a consequence of the nucleophilic attack on the carbonyl carbon of the cyclic ring by the perhydroxide anion. For instance, this ring-opening reaction in caprolactam activators involves attack at the caprolactam ring carbonyl by hydrogen peroxide or its anion. Another example of ring-opening bleach activators can be found in the benzoxazin type activators.

Such activator compounds of the benzoxazin-type, have the formula:

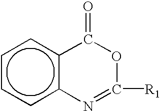

including the substituted benzoxazins of the type

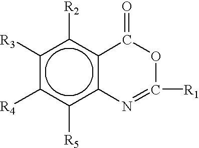

wherein R₁ is H, alkyl, alkaryl, aryl, arylalkyl, and wherein R₂, R₃, R₄, and R₅ may be the same or different substituents selected from H, halogen, alkyl, alkenyl, aryl, hydroxyl, alkoxyl, amino, alkyl amino, COOR₆ (wherein R₆ is H or an alkyl group) and carbonyl functions.

A preferred activator of the benzoxazin-type is:

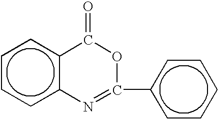

N-acyl caprolactam bleach activators may be employed in the present invention. These activators have the formula:

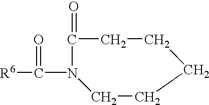

wherein R⁶ is H or an alkyl, aryl, alkoxyaryl, or alkaryl group containing from 1 to 12 carbons. Caprolactam activators wherein the R⁶ moiety contains at least about 6, preferably from 6 to about 12, carbon atoms provide hydrophobic bleaching.

Highly preferred hydrophobic N-acyl caprolactams are selected from the group consisting of benzoyl caprolactam, octanoyl caprolactam, nonanoyl caprolactam, decanoyl caprolactam, undecenoyl caprolactam, 3,5,5-trimethylhexanoyl caprolactam, and mixtures thereof.

Alternatively, a pre-formed peracid may be employed in lieu of the peroxide and activator. The pre-formed hydrophobic peracids are preferably selected from the group consisting of percarboxylic acids and salts, percarbonic acids and salts, perimidic acids and salts, peroxymonosulfuric acids and salts, and mixtures thereof examples of which are described in U.S. Pat. No. 5,576,282 to Miracle et al.

One class of suitable organic peroxycarboxylic acids have the general formula:

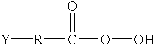

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Organic peroxyacids suitable for use in the present invention can contain either one or two peroxy groups and can be either aliphatic or aromatic. When the organic peroxycarboxylic acid is aliphatic, the unsubstituted peracid has the general formula:

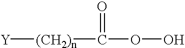

where Y can be, for example, H, CH₃, CH₂Cl, C(O)OH, or C(O)OOH; and n is an integer from 0 to 20. When the organic peroxycarboxylic acid is aromatic, the unsubstituted peracid has the general formula:

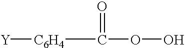

wherein Y can be, for example, hydrogen, alkyl, alkylhalogen, halogen, C(O)OH or C(O)OOH.

Typical monoperoxy acids useful herein include alkyl and aryl peroxyacids such as:

(i) peroxybenzoic acid and ring-substituted peroxybenzoic acid, e.g. peroxy-a-naphthoic acid, monoperoxyphthalic acid (magnesium salt hexahydrate), and o-carboxybenzamidoperoxyhexanoic acid (sodium salt);

(ii) aliphatic, substituted aliphatic and arylalkyl monoperoxy acids, e.g. peroxylauric acid, peroxystearic acid, N-nonanoylaminoperoxycaproic acid (NAPCA), N,N-(3-octylsuccinoyl)aminoperoxycaproic acid (SAPA) and N,N-phthaloylaminoperoxycaproic acid (PAP);

(iii) amidoperoxyacids, e.g. monononylamide of either peroxysuccinic acid (NAPSA) or of peroxyadipic acid (NAPAA).

Typical diperoxyacids useful herein include alkyl diperoxyacids and aryldiperoxyacids, such as:

(iv) 1,12-diperoxydodecanedioic acid;

(v) 1,9-diperoxyazelaic acid;

(vi) diperoxybrassylic acid; diperoxysebacic acid and diperoxyisophthalic acid;

(vii) 2-decyldiperoxybutane-1,4-dioic acid;

(viii) 4,4′-sulfonylbisperoxybenzoic acid.

Such bleaching agents are disclosed in U.S. Pat. No. 4,483,781, Hartman, issued Nov. 20, 1984, U.S. Pat. No. 4,634,551 to Burns et al., European Patent Application 0,133,354, Banks et al. published Feb. 20, 1985, and U.S. Pat. No. 4,412,934, Chung et al. issued Nov. 1, 1983. Sources also include 6-nonylamino-6-oxoperoxycaproic acid as fully described in U.S. Pat. No. 4,634,551, issued Jan. 6, 1987 to Bums et al. Persulfate compounds such as for example OXONE, manufactured commercially by E. I. DuPont de Nemours of Wilmington, Del. can also be employed as a suitable source of peroxymonosulfuric acid.

The activator as selected above is typically present in the invention in a ratio of activator to peroxide of from about 1:1 to about 1:50, more preferably from about 1:2 to about 1:30 and most preferably in a ratio of about 1:5 to about 1:20 for hot processing and 1:3 to about 1:15 for cold processing.

The bleaching solution of the present invention also includes the aforementioned peracid stabilization system. The peracid stabilization system of the present invention is a system designed for providing chemical stability to the peracid thereby enhancing the bleaching effect and contributing to the superior performance of the present invention. The peracid stabilization system of the present invention is preferably selected from organic phosphonic acids and their salts. Particularly preferred are the di or multi phosphonic acids and their salts and in particular the substituted diphosphonic acids such as 1-hydroxyethylidene-1,1-diphosphonic acid and the amino phosphonic acids and their salts and in particular the methyl substituted amino phosphonic acids such as the amino penta (methylenephosphonic acids), the amino tetra (methylenephosphonic acids), and the amino tri (methlyenephosphonic acids). Most preferred among these materials is diethylene triamine penta(methylenephosponic acid).

The peracid stabilizers of the present invention are typically employed at levels of from about 0.01 to about 10 g/L, more preferably from about 0.1 to about 5 g/L, and most preferably from about 0.2 to about 4 g/L. For the preferred di or multi phosphonic acids, the levels typically range from a molar ratio of peracid to disphonic acid of from about 1:1 to about 75:1, more preferably from about 2:1 to 35:1 and most preferably in hot processing from about 2:1 to about 20:1 and in cold processing from about 2:1 to about 15:1.

Meanwhile levels of the preferred amino phosphonic acids typically range from a molar ratio of peracid to amino phosphonic acid of from about 1:1 to about 200:1, more preferably from about 4:1 to 100:1 and most preferably in hot processing from about 4:1 to about 60:1 and in cold processing from about 4:1 to about 40:1.

A highly preferred peracid stabilization system under the present invention is a combination of 1-hydroxyethylidene-1,1-diphosphonic acid and diethylene triamine penta(methylenephosponic acid).

The aqueous bleaching solution of the method of the present invention may be delivered via several routes. Most preferred is via the use of a concentrated precursor solution of the aforementioned ingredients. In such a scenario, a bleach precursor solution having at least about 8% by weight, more preferably more than about 10% of a hydrophobic bleach precursor and peracid stabilizing system wherein the ratio of activator to stabilizer is from about 2:1 to about 20:1 active weight basis. The hydrophobic bleach precursor may be a pre-formed peracid or the aforementioned preferred hydrophobic bleach activator which when mixed with hydrogen peroxide in the textile application forms a peracid. The bleach precursor composition may take several forms such as powder, slurry or liquids, with liquids and slurry's being the most preferred.

A bleach precursor in slurry form allows a single source of supply for all ingredients such as activator, peracid stabilizer and any adjunct ingredients which may be desired such as anti-foaming agents, wetting agents, surfactants, etc. In slurry, the concentration of the preferred activator may be more than 50% by weight activator with more than 70% being the most preferred. A bleach precursor in liquid form allows for ease of handling and shipping. In liquid form the preferred activator has a concentration of at least 8%, preferably more than 10%. In preferred scenarios of bleach precursor in liquid form, the precursor is split in at least two separate liquid compositions with one consisting of activator and any desired adjunct ingredients and the other consisting of the peracid stabilization system. Separation of the peracid stabilization system from the activator in a liquid system allows for higher levels of activator in solution such as about 15% and even more preferably more than about 20%.

The bleaching solutions and precursors thereto of the present invention may also include various adjunct ingredients. Such ingredients include wetting agents, pH control agents, bleach catalysts, peroxide stabilizing agents, detergents and mixtures thereof. Wetting agents are typically selected from surfactants and in particular nonionic surfactants. When employed, wetting agents are typically included at levels of from about 0.1 to about 20 g/L, more preferably from about 0.2 to about 15 g/L, and more preferably 0.2 to about 10 g/L of the bath for hot processing and from about 0.1 to about 20 g/L, more preferably from about 0.5 to about 20 g/L, and more preferably 0.5 to about 10 g/L for cold processing. Stabilizing agents are employed for a variety of reasons including buffering capacity, sequestering, dispersing and in addition enhancing the performance of the surfactants. Stabilizing agents are well known with both inorganic or organic species being well known and silicates and organophosphates gaining the broadest acceptance and when present are employed at levels of from about 0 to about 10 g/L, more preferably from about 0.1 to about 5 g/L and most preferably from about 0.2 to about 4 g/L of the bath for hot processing and from about 0 to about 30 g/L, more preferably from about 0.1 to about 20 g/L, and more preferably 0.1 to about 10 g/L for cold processing. In preferred optional embodiments of the present invention, sodium hydroxide is included in the bleaching solution at levels of from about 0.5 to about 40 g/L, more preferably from about 1 to about 30 g/L and most preferably at levels of from about 2 to about 20 g/L for hot processing and from about 1.0 to about 50 g/L, more preferably from about 5 to about 40 g/L, and more preferably 10 to about 30 g/L, for cold processing.

The method of the present invention involves providing a non-finished textile component into the bleaching solution as described. The textile component may comprise fibers, yarns and fabrics including wovens, nonwovens and knits. By non-finished, it is intended that the textile component be a material that has not been dyed, printed, or otherwise provided a finishing step such as durable press finish. Of course, one of ordinary skill in the art will recognize that the textile component of the present invention are those that have not been passed through a garment or other manufacturing process involving cutting and sewing of the material.

The present process may be employed with most any natural material including cellulosics such as cotton, linen and regenerated cellulosics such as rayon and lyocell. Both 100% natural fibers, yarns and fabrics may be employed or blends with synthetic materials may be employed as well. For the purposes of the present invention, natural fibers may include cellulosics as described herein, wools both pure and blends, silks, sisal, flax and jute.

As mentioned throughout, the present invention may be employed in both hot batch and hot continuous processing or cold batch processing, all three of which are well known in the art. Hot batch and continuous processing in the present invention involve the application of peroxide bleaching solutions at elevated temperatures ranging from up to about 95° C. with temperatures ranging from about 40 to about 80° C. being more typical and 50-70° being most preferred. Reactions times range from 15 to about 180 minutes, more typically 20 to about 120 minutes and most preferably 30 to about 60 minutes with liquor to fabric ratios of from about 5:1 to about 100:1 with about 5:1 to about 40:1 being more preferred and from about 5:1 to about 20:1 being the most preferred for hot batch. For continuous processing, preferred wet pick-up is from about 50% to about 200 weight percent % of the fabric, more preferably from about 50% to about 150% and most preferably from about 70% to about 130%

The cold batch process of the present invention involves pumping the bleaching solution of the present invention into a padding trough and passing a textile component such as a fabric through the trough to saturate the fabric with the bleaching solution. Padding temperatures range from 10 to about 90° C. with about 10 to about 50° C. being more preferred and from about 20 to about 40° C. being most preferred. While fabric pick up of the bleaching solution varies by fabric, typical wet pick up of bleach solution on the fabric ranges from about 50% to about 200% on weight of the fabric, more preferably from about 50% to about 150% and most preferably from about 70% to about 130% by weight on fabric.

Once saturated, the fabric is rolled on a beam, wrapped and treated on a frame for the desired period of time at room temperature. Preferred frames include a rotating A frame and fabric rolls are rotated at specified times to ensure even distribution of the bleaching solution. Rotation times typically are from about 2 to about 8 hours. Following the requisite treatment time, the treated textile is washed to remove the bleaching solution. One of ordinary skill in the art will of course recognize that conventional cold batch processing equipment may be employed in the method of the present invention.

The method of the present invention may include the further steps of singeing, de-sizing, scouring, and mercerization in conjunction with the bleaching step as are well known in the art. These steps may be performed in various-combinations and orders and one of ordinary skill in the art will recognize that varying combinations are possible.

Of course the process of the present invention includes in the preferred applications a washing step or series of washing steps following the method of the present invention. Washing of treated textiles is well known and within the level of skill of the artisan. Washing stages will be typically present after each of the de-sizing, scouring and mercerization steps when present as well as after the bleaching step of the present invention. Washing of treated textiles of the present invention may be performed in known washing equipment such as a jet washing machine. Washing typically involves multiple washings at elevated temperatures followed by step-wise reduction of the temperatures and times across the stages, e.g. approx 80° C. for 10 minutes to approx. 70° C. for 10 minutes to approx. 28° C. for 3 minutes to approx. 70° C. for 5 minutes. In addition, various additives such as chelants and acidic reagents may be added to the rinse solutions if desired. Lastly, the bleaching, de-sizing, scouring or mercerization steps when present may in preferred embodiments include a wet-out or pre-wetting step to ensure even or uniform wettness in the textile component.

For purposes of the present invention, fiber degradation or damage is based on fluidity as measured via AATCC test method 82-1996 involving the dispersion of the fibers in cupriethylene diamine (CP). An increase in fluidity between treated fibers and non-treated fibers represents an increase in the amount of fiber damage. The method employed is outlined as follows. A representative sample of fibers of about 1.5 mm is cut and dissolved in CP as defined by the equation CP=120×sample weight×0.98 in a specimen bottle with several glass balls, placed under nitrogen. The bottle is shaken for approximately 2 hours. Additional CP is added as defined by the equation CP=80×sample weight×0.98 followed by additional shaking under nitrogen for three hours. Following dissolution, the solution is placed under constant stirring to prevent separation of the dispersion. The solution is then measured in a calibrated Oswald Canon Fenske viscometer in a constant temperature bath of 25° C. to determine the efflux time. Efflux time is determined by drawing the fluid to a mark between 2 bulbs and measuring the time required for the meniscus to pass from the mark between the bulbs to the mark below the lower bulb. The average of two times is used. Fluidity is then calculated from the formula F=100/ctd, where c=viscometer constant, t=efflux time and d=density of the solution 1.052.

The following non-limiting examples further illustrate the present invention.

### EXAMPLE I

A process for the cold batch bleaching woven fabrics according to the present invention may be conducted in the following manner. The bleaching bath is prepared by adding the chemicals as outlined in Table I below to tap water. The addition sequence is as follows: Water-Wetting agent—detergent—Peracid stabilizer/peroxide stabilzer—Activator(when present)—H₂O₂—NaOH. The fabric was a unde-sized and unscoured greige plain weave (400R). The original fabric whiteness was 18 on the CIE scale. The bleaching bath is pumped into a padding trough and keep at a constant near full level throughout the padding. The fabric is passed through at a padding speed of 30 m/min. at approx. 24° C., rolled up on a beam and sealed in plastic sheating. The fabric is then rotated on an A-frame at room temperature for the specified reaction time then rinsed thoroughly in a jet washing machine. The bleached fabric is dried and conditioned under 70 F and 65% relative humidity for wetting and whiteness measurements. Miniscan XE Plus made by HunterLab was used to measure CIE Whiteness Index. An Instron was used to evaluate the tensile strength by following the method ASTM D 5035. Fluidity was measured by AATCC Test Method 82.

TABLE I

| | A | B |
|---|---|---|
| NaOH (50%) (g/l) | 40 | 40 |
| H₂O₂ (35%) (g/l) | 40 | 40 |
| Activator (g/L)¹ | None | 27.7 |
| Molar Ratio (Activator/H₂O₂) | NA | 1:5 |
| Peroxide Stabilizer² (g/l) | 5 | None |
| Wetting Agent³ (g/l) | 3 | 3 |
| Peracid Stabilizer⁴ | None | 6 |
| Detergent (g/l)⁵ | 10 | 10 |
| Time (hours) | 24 | 4 |
| CIE Whiteness | 66.1 | 71.7 |
| Fluidity | 1.00 | 1.02 |
| Tensile Strength (lbs) | 41.40 | 48.07 |

¹nonanoyloxybenezene sulfonate, sodium salt, NOBS.
²Prestogen K from BASF in stock active level.
³Leophen NAM from BASF in stock active level.
⁴A mixture of 4 g/L of diethylene triamine penta(methylenephosponic acid) and 2 g/L 1-hydroxyethylidene-1,1-diphosphonic acid
⁵Kierlon Jet B from BASF in stock active level.

### EXAMPLE II

A process for the hot batch bleaching of woven fabrics according to the present invention may be conducted in the following manner. The bleaching solution is formed by preparing a premix of the peracid stabilizer by diluting the respective components to approx. 25% active and adjusting pH with caustic to the range of 5-5.5. Following preparation of the stabilizer premix, an bleach precursor premix is prepared by mixing ingredient in the following order: Activator (when present)—Water—Wetting agent—suds suppressor (if desired) and stabilizer premix. The bleaching solution is then prepared and added to a jet machine by adding the following ingredients in the listed order in the machine: Lubricant—bleach precursor mix—Fabric Load—detergent (when present)—H₂O₂—NaOH. The liquor/fabric ratio in the machine is 10:1. The temperature of the solution is raised to 70° C. at 3° C./min. Upon achieving the temperature, the solution temperature is maintained for 40 minutes followed by draining of the bleaching solution from the machine. The machine is refilled with 70° C. water, overflowed for 10 min, and then drain again. A second rinse is conducted by filling the machine with 40° C. water, adding acetic acid to pH 6.0 and running the machine for 5 minutes and draining. A third rinse is performed identical to the first and a fourth and final rinse by refilling with cold water, running 5 minutes and draining is conducted. The bleached fabrics are then dried on a tent frame. Tensile strength was measured using ASTM D 5035 (Raveled Strip). Fluidity was measured using AATCC 82. Fabric whiteness was measured using CIElab whiteness index.

TABLE II

| | A | B |
|---|---|---|
| NaOH (50%) (g/l) | 4.0 | 4.0 |
| H₂O₂ (35%) (g/l) | 5.0 | 5.0 |
| Activator (g/L) | None | 2.1 |
| Molar Ratio (Activator/H₂O₂) | NA | 1:10 |
| Peroxide Stabilizer² (g/l) | 0.4 | None |
| Wetting Agent³ (g/l) | 0.5 | 0.5 |
| Peracid Stabilizer⁴ | None | 0.6 |
| Detergent (g/l)⁵ | 1.0 | None |
| Lubricant)⁶ | 0.75 | 0.75 |
| CIE Whiteness | 65.7 | 71.9 |
| Fluidity | 2.84 | 1.40 |
| Tensile Strength (lbs) | 41.6 | 44.1 |

¹nonanoyloxybenezene sulfonate, sodium salt, NOBS.
²Prestogen K from BASF in stock active level.
³Leophen NAM from BASF in stock active level.
⁴A mixture of 4 g/L of diethylene triamine penta(methylenephosponic acid) and 2 g/L 1-hydroxyethylidene-1,1-diphosphonic acid
⁵Kierlon Jet B from BASF in stock active level.
⁶Multiplus NB 100 from BASF in stock active level.

What is claimed is:

1. A method for the preparation of a non-finished textile component comprising the steps of providing a non-finished textile component, contacting said textile component with an aqueous bleaching solution comprising a hydrophobic peracid and a peracid stabilizing system wherein said peracid stabilizer is present at a peracid to stabilizer ratio of from about 1:1 to about 100:1 and allowing said bleaching solution to remain in contact with said textile component for a period of time sufficient to bleach said textile component.

2. The method as claimed in claim 1 wherein said hydrophobic peracid is formed from the combination of hydrogen peroxide and a hydrophobic bleach activator selected from the group consisting of:
a) a bleach activator of the general formula: 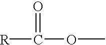
wherein R is an alkyl chain having from about 5 to about 17 carbon atoms and L is a leaving group;
b) a bleach activator of the general formula: 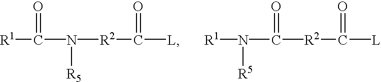
or mixtures thereof, wherein R¹ is an alkyl, aryl, or alkaryl group containing from about 1 to about 14 carbon atoms, R² is an alkylene, arylene or alkarylene group containing from about 1 to about 14 carbon atoms, R⁵ is H or an alkyl, aryl, or alkaryl group containing from about 1 to about 10 carbon atoms, and L is a leaving group;
c) a benzoxazin-type bleach activator of the formula: 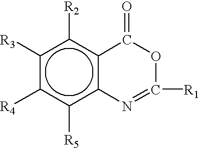
wherein R₁ is H, alkyl, alkaryl, aryl, arylalkyl, and wherein R₂, R₃, R₄, and R₅ may be the same or different substituents selected from H, halogen, alkyl, alkenyl, aryl, hydroxyl, alkoxyl, amino, alkylamino, —COOR₆, wherein R₆ is H or an alkyl group and carbonyl functions;
d) a N-acyl caprolactam bleach activator of the formula: 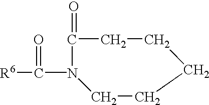
wherein R₆ is H or an alkyl, aryl, alkoxyaryl, or alkaryl group containing from 1 to 12 carbons; and
e) mixtures of a,b,c and d.

3. The method as claimed in claim 2 wherein said bleach activator is an alkanoyloxybenzenesulfonates of the formula: 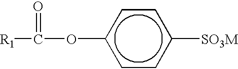
wherein R₁ is an alkyl group having from about 7 to about 11 carbon atoms and M is a suitable cation.

4. The method as claimed in claim 1 wherein said peracid stabilizing system comprises one or more organic phosphonic acids or organic phosponates.

5. The method as claimed in claim 4 wherein said peracid stabilizer system comprises one or more compounds selected from the group consisting of substituted diphosphonic acids, substituted multiphosphonic acids, amino phosphonic acids and mixtures thereof.

6. The method as claimed in claim 5 wherein said peracid stabilizer system comprises a diphosphonic acids and at least one amino phosphonic acid selected from the group of amino penta (methylenephosphonic acids), amino tetra (methylenephosphonic acids), amino tri (methlyenephosphonic acids) and mixtures thereof, wherein the molar ratio of peracid to diphosphonic acid is from about 2:1 to about 35:1 and the molar ratio of peracid to amino phosphonic acid is from about 4:1 to about 100:1.

7. The method as claimed in claim 6 wherein said peracid stabilizer is a mixture of 1-hydroxyethylidene-1,1-diphosphonic acid and diethylene triamine penta(methylenephosponic acid).

8. The method as claimed in claim 2 wherein said hydrogen peroxide and said hydrophobic bleach activator are present in a molar ratio of activator to peroxide of from about 1:2 to about 1:30.

9. The method as claimed in claim 1 wherein the resultant treated textile component has a whiteness value on the CIE index of at least about 70 or a fiber degradation increase of less than 25%.

10. The method as claimed in claim 1 wherein said bleaching solution further includes a suds suppressor system.

11. A textile hydrophobic bleach precursor composition comprising at least about 8% by weight of a hydrophobic bleach precursor and peracid stabilizing system wherein the ratio of activator to stabilizer is from about 2:1 to about 20:1 active weight basis.

12. The textile bleach precursor composition as claimed in claim 11 wherein said composition is in slurry form and said composition comprises at least about 50% by weight of said hydrophobic bleach precursor.

13. The textile bleach precursor composition as claimed in claim 11 wherein said hydrophobic bleach precursor is a hydrophobic bleach activator selected from the group consisting of:
a) a bleach activator of the general formula: 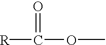
wherein R is an alkyl chain having from about 5 to about 17 carbon atoms and L is a leaving group;
b) a bleach activator of the general formula: 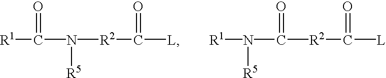
or mixtures thereof, wherein R¹ is an alkyl, aryl, or alkaryl group containing from about 1 to about 14 carbon atoms, R² is an alkylene, arylene or alkarylene group containing from about 1 to about 14 carbon atoms, R⁵ is H or an alkyl, aryl, or alkaryl group containing from about 1 to about 10 carbon atoms, and L is a leaving group;
c) a benzoxazin-type bleach activator of the formula: 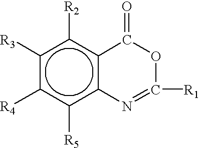
wherein R₁ is H, alkyl, alkaryl, aryl, arylalkyl, and wherein R₂, R₃, R₄, and R₅ may be the same or different substituents selected from H, halogen, alkyl, alkenyl, aryl, hydroxyl, alkoxyl, amino, alkylamino, —COOR₆, wherein R₆ is H or an alkyl group and carbonyl functions;
d) a N-acyl caprolactam bleach activator of the formula: 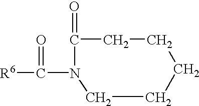
wherein R⁶ is H or an alkyl, aryl, alkoxyaryl, or alkaryl group containing from 1 to 12 carbons; and
e) mixtures of a,b,c and d.

14. The method as claimed in claim 11 wherein said stabilizing system comprises one or more compounds selected from the group consisting of substituted diphosphonic acids, substituted multiphosphonic acids, amino phosphonic acids and mixtures thereof.

15. A hydrophobic bleach precursor system for the bleaching of non-finished textiles comprising a least a first composition comprising at least about 10% by weight of a hydrophobic bleach precursor and at least a second composition comprising a peracid stabilizing system.

16. The bleach precursor system as claimed in claim 15 wherein the hydrophobic bleach precursor is present in said first composition at a concentration of at least about 15% by weight.

17. The bleach precursor system as claimed in claim 16 wherein said hydrophobic bleach precursor is a hydrophobic bleach activator selected from the group consisting of:
a) a bleach activator of the general formula: 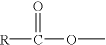
wherein R is an alkyl chain having from about 5 to about 17 carbon atoms and L is a leaving group;
b) a bleach activator of the general formula: 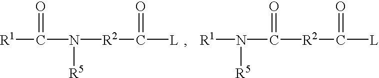
or mixtures thereof, wherein R¹ is an alkyl, aryl, or alkaryl group containing from about 1 to about 14 carbon atoms, R² is an alkylene, arylene or alkarylene group containing from about 1 to about 14 carbon atoms, R⁵ is H or an alkyl, aryl, or alkaryl group containing from about 1 to about 10 carbon atoms, and L is a leaving group;
c) a benzoxazin-type bleach activator of the formula: 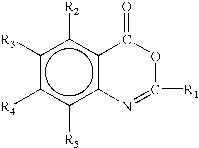
wherein R₁ is H, alkyl, alkaryl, aryl, arylalkyl, and wherein R₂, R₃, R₄, and R₅ may be the same or different substituents selected from H, halogen, alkyl, alkenyl, aryl, hydroxyl, alkoxyl, amino, alkylamino, —COOR₆, wherein R₆ is H or an alkyl group and carbonyl functions;
d) a N-acyl caprolactam bleach activator of the formula: 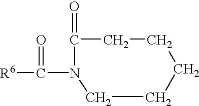
wherein R⁶ is H or an alkyl, aryl, alkoxyaryl, or alkaryl group containing from 1 to 12 carbons; and
e) mixtures of a,b,c and d.

18. The bleach precursor system as claimed in claim 15 wherein said stabilizing system comprises one or more compounds selected from the group consisting of substituted diphosphonic acids, substituted multiphosphonic acids, amino phosphonic acids and mixtures thereof.

19. The bleach precursor system as claimed in claim 15 wherein said system further includes a suds suppressor.

20. The method as claimed in claim 18 wherein said peracid stabilizer system comprises a diphosphonic acids and at least one amino phosphonic acid selected from the group of amino penta (methylenephosphonic acids), amino tetra (methylenephosphonic acids), amino tri (methlyenephosphonic acids) and mixtures thereof, wherein the molar ratio of peracid to diphosphonic acid is from about 2:1 to about 35:1 and the molar ratio of peracid to amino phosphonic acid is from about 4:1 to about 100:1.
